(19) United States
(12) Patent Application Publication
(10) Pub. No.: US 2004/0186744 A1
(43) Pub. Date: Sep. 23, 2004

(54) Patient registration kiosk

(76) Inventor: Cindy M. Lux, Brighton, MA (US)

Correspondence Address: MAINE & ASMUS, 100 MAIN STREET, P O BOX 3445, NASHUA, NH, 03061-3445, US

(21) Appl. No.: 10/802,334

(22) Filed: Mar. 17, 2004

Related U.S. Application Data
(60) Provisional application No. 60/455,138, filed on Mar. 17, 2003.

(51) Int. Cl. G06F 17/60

(52) U.S. Cl. 705/2

(57) ABSTRACT

A patient registration kiosk is disclosed, which makes the patient registration process in a healthcare setting (e.g., a hospital, physician's office, or other healthcare providing institution) a self serve function, thereby reducing labor costs associated with providing healthcare. By putting the process in the hands of the patient, the information is more likely to be current and accurate. A scanned image of the patient's insurance card, as well as other pertinent insurance and patient information, is stored for use by the healthcare provider's staff, including front-end staff (e.g., reception personnel) and back-end staff (e.g., billing personnel). Note that the stored patient and insurance information can be utilized for all billing-related purposes, and is available to confirm eligibility (before patient's appointment) and at the time when the services are billed to the insurance company (after patient's appointment). As such, claims are billed accurately, thereby enabling a reduction in billing cycle time, and an increase in revenue received for healthcare services provided.

### RELATED APPLICATIONS

This application claims the benefit of U.S. Provisional Application No. 60/455,138, filed Mar. 17, 2003, which is herein incorporated in its entirety by reference.

### FIELD OF THE INVENTION

The invention relates to healthcare administration, and more particularly, to a patient registration kiosk that enables both self-registration for the patient, and efficient and accurate data for billing and claim management by the care provider.

### BACKGROUND OF THE INVENTION

The conventional patient registration processes that are employed by many healthcare institutions are fragmented, manual processes that require staff of the healthcare provider, whether in a hospital or physician office setting, to ask the patient a series of questions regarding patient (e.g., name, address, social security number, etc.) and insurance information (e.g., payor, plan type, co-pay, etc.). A staff member typically enters the information into the provider's system. The staff member may further photocopy the patient's health insurance card.

This intake process usually results in information that can be obtained only locally (i.e., to the particular department being visited by the patient, such as Internal Medicine, Radiology, Surgery, etc.). Thus, other departments of the healthcare provider that the patient visits in the same day may not have all of the patient's current information. For example, the patient's insurance carrier could have changed since her last visit to that particular department. If the new patient data obtained by the first department during registration is not accessible by the second department, then that second department's incorrect data may cause a significant delay in the claim process, thereby jeopardizing that department's chance of being paid for its service.

In addition, the conventional registration process requires training and knowledge on the part of the healthcare provider staff to know about the variety of payors and plans that each payor offers. Typically, a staff member selects the insurance payor and plan, from an existing database within the healthcare provider's information/billing system. Often times this insurance information is not current, complete, or is otherwise inaccurate. This is because staff members may be too busy to review or edit this information each time a patient visits, or because there is a knowledge or training issue on the part of the staff with regard to payor or plan selection. As a result, a significant amount of work (e.g., research and follow-up communication with insurance carriers) by billing personnel within the healthcare provider's billing office is necessitated.

Moreover, billing personnel rely on such plan and payor information to get reimbursement for services rendered. Thus, in addition to the time and resources expended, the chance for lost revenue is also significant. For instance, in a large institution (e.g., teaching hospital), it is not uncommon for millions of dollars in outpatient charges to be delayed every month due to registration errors. A significant percentage of this money is ultimately declared lost revenue. This problem is exacerbated because healthcare providers are under increasing pressure by insurance companies to submit claims as close to the date of service as possible. Some insurance companies impose filing limits, many of which are 60-90 days from the date of service.

What is needed, therefore, are efficient, effective and accurate techniques for facilitating patient registration, insurance eligibility confirmation, and billing processes in the healthcare industry.

### SUMMARY OF THE INVENTION

One embodiment of the present invention provides a patient registration kiosk system that allows patients to self-register for an appointment with a healthcare provider. The system includes a patient identification mechanism adapted to uniquely identify a patient so that information relevant to that patient can be retrieved from a database. A user interface is provided that presents the retrieved information to the patient and allows the patient to update the information as necessary, thereby maintaining current patient information in the database. An insurance plan identification mechanism is adapted to identify insurance plan information including a payor associated with the patient, thereby maintaining current insurance information in the database. A data interface is also provided, that enables the healthcare provider to form an electronic communication link with the payor to confirm the patient's eligibility for coverage by the payor, based on the identified insurance plan information. An insurance card scanner is adapted to generate an image of each side of an insurance card associated with the patient for storage in the database.

In one such embodiment, the system further includes an output device that is adapted to provide a receipt relevant to the patient's appointment. The receipt includes, for example, at least one of patient name, unique patient identifier, insurance payor name, plan name or type, patient insurance member number, eligibility confirmation, and office co-pay amount. The patient identification mechanism can be, for example, one of a barcode scanner and a card reader. The user interface can be, for example, a touch screen graphical user interface that allows the patient to interact with the kiosk system. The insurance plan identification mechanism can be, for example, one of a barcode scanner and a card reader. The data interface may form part of an electronic data interchange (EDI) between the healthcare provider and the payor.

The system may further include a processor in communication with one or more of the patient identification mechanism, the user interface, the insurance plan identification mechanism, the data interface, and the insurance card scanner, wherein the processor is configured for controlling functionality of the kiosk system. The system can be coupled to a network that includes at least one of a front desk workstation and a billing workstation, with each workstation having access to the database. The system can be coupled to a network that includes a server that communicatively couples the database to the kiosk system. In one such embodiment, the server communicatively couples the database and the kiosk system to a billing system associated with the healthcare provider. Here, the data interface operates in conjunction with the server and the billing system to form the electronic communication link between the healthcare provider and the payor to confirm the patient's eligibility for coverage.

Another embodiment of the present invention provides a patient registration kiosk system that allows patients to self-register for an appointment with a healthcare provider. The system includes a barcode scanner adapted to uniquely identify a patient so that information relevant to that patient can be retrieved from a database. A user interface is provided that presents the retrieved information to the patient and allows the patient to update the information as necessary, thereby maintaining current patient information in the database. A card reader is adapted to identify insurance plan information including a payor associated with the patient, thereby maintaining current insurance information in the database. A data interface is provided that allows the healthcare provider to confirm the patient's eligibility for coverage by the payor based on the identified insurance plan information. An insurance card scanner is adapted to generate an image of each side of an insurance card associated with the patient for storage in the database. An output device is adapted to provide a paper receipt relevant to the patient's appointment. The receipt includes, for example, at least one of patient name, unique patient identifier, insurance payor name, plan name or type, patient insurance member number, eligibility confirmation, and office co-pay amount. The user interface may include, for example, a touch screen graphical user interface.

In one such embodiment, the system further includes a processor in communication with one or more of the barcode scanner, the user interface, the card reader, the data interface, and the insurance card scanner, wherein the processor is configured for controlling functionality of the kiosk system. The system can be coupled to a network that includes at least one of a front desk workstation and a billing workstation, with each workstation having access to the database. The system can be coupled to a network that includes a server that communicatively couples the database, the kiosk system, and a billing system associated with the healthcare provider. Here, the data interface operates in conjunction with the server and the billing system to form a communication link between the healthcare provider and the payor to confirm the patient's eligibility for coverage.

Another embodiment of the present invention provides a patient registration kiosk system that allows patients to self-register for an appointment with a healthcare provider. The system includes a patient identification mechanism that is adapted to uniquely identify a patient so that information relevant to that patient can be retrieved from a database. A user interface is provided that presents the retrieved information to the patient and allows the patient to update the information as necessary, thereby maintaining current patient information in the database. An insurance plan identification mechanism is adapted to identify insurance plan information including a payor associated with the patient, thereby maintaining current insurance information in the database. A data interface is provided that allows the healthcare provider to confirm the patient's eligibility for coverage by the payor based on the identified insurance plan information.

In one such embodiment, the kiosk system is coupled to a network that includes a server that communicatively couples the database to the kiosk system. The server may further have electronic access to current payor provider manuals and/or sample insurance card images associated with one or more payors. In another such embodiment, at least one of a network and a server is used to communicatively couple the database and the kiosk system to a billing system associated with the healthcare provider. Here, the data interface can operate in conjunction with the server and the billing system to establish electronic communication between the healthcare provider and the payor to confirm the patient's eligibility for coverage.

In another such embodiment, the system can be coupled to a network that includes at least one of a front desk workstation and a billing workstation, with each workstation having access to the database. Here, each workstation could have electronic access, for example, to current versions of payor provider manuals and sample insurance card images (whether accessed locally or remotely by the Internet). At least one of the workstations can be adapted to provide a split-screen display that allows a staff member of the healthcare provider to compare images of an insurance card associated with the patient with sample insurance card images provided by the payor. In another such embodiment, the kiosk system further includes a payment-intake mechanism (e.g., cash, check, or credit card) configured to receive payment including at least one of a co-pay and an outstanding balance associated with the patient. The data interface may further allow the healthcare provider to confirm a co-pay and/or particular plan benefits (e.g., specific medical procedures and services covered by the plan) associated with the patient. The identified insurance plan information may further include, for example, a specific plan associated with the patient.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an illustration of a patient registration kiosk configured in accordance with one embodiment of the present invention.

FIG. 2 is a block diagram of a kiosk local processing system configured in accordance with one embodiment of the present invention.

FIG. 3 is a block diagram of a networked system including patient registration kiosks and various workstations in a healthcare provider setting, in accordance with one embodiment of the present invention.

FIG. 4 is a block diagram of a kiosk server interfaced with various billing systems in accordance with one embodiment of the present invention.

FIG. 5 illustrates an example confirmation/receipt provided by a kiosk system in accordance with one embodiment of the present invention.

FIG. 6 is a block diagram of a kiosk server interfaced with a number of payors via an HTML server in accordance with one embodiment of the present invention.

FIGS. 7a-7i illustrate example screen shots of a user interface for staff members of a healthcare provider using a kiosk system configured in accordance with one embodiment of the present invention.

FIGS. 8a-8g illustrate example screen shots of a user interface for patients of a healthcare provider using a kiosk system configured in accordance with one embodiment of the present invention.

### DETAILED DESCRIPTION OF THE INVENTION

One embodiment of the present invention enables a self-registration process for patients, and allows the healthcare provider's staff throughout the institution (e.g., hospital and physician's office) to have access to accurate and up-to-date patient information. The patient information includes, for example, patient name, address, social security, health insurance type, and other related health insurance information, such as a scanned image of the patient's health insurance card (both sides). The scanned image of the insurance card is date stamped to allow for timeliness of the image to be assessed in relation to the service date.

Various benefits can be realized by employing the principles of the present invention, including reduction in labor costs (e.g., hospital registration staff, physician office staff, and billing staff), improved accuracy of registration information (e.g., patient and insurance), increase in timely and accurate claim filings, and a decrease in lost revenue for hospital and physician practices.

Kiosk Configuration

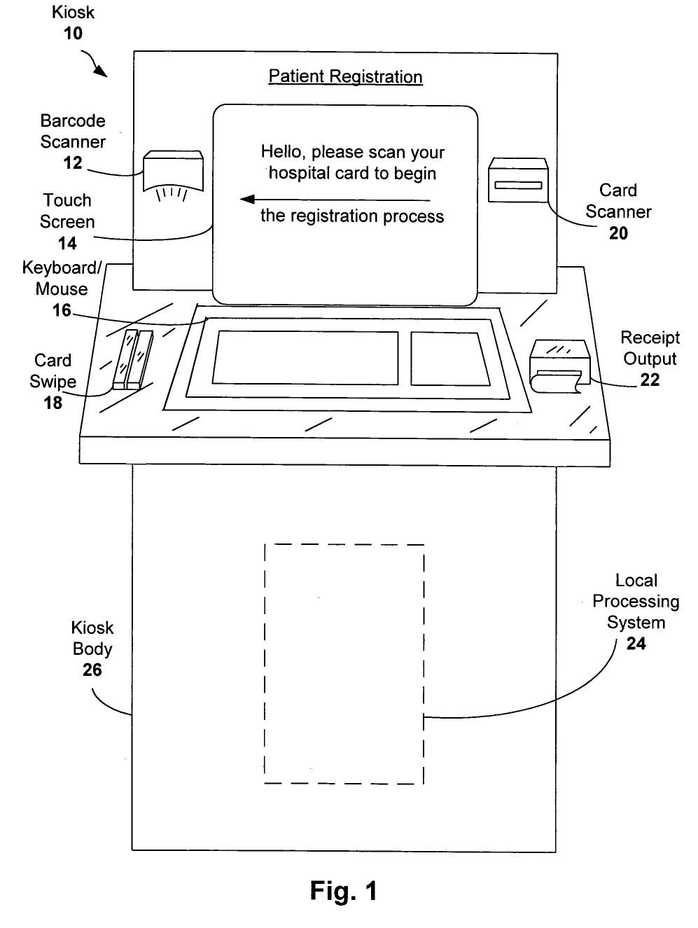

FIG. 1 is an illustration of a patient registration kiosk configured in accordance with one embodiment of the present invention. In particular, kiosk 10 includes a barcode scanner 12, a touch screen or monitor 14, a keyboard/mouse 16, a card reader 18, a card scanner 20, a receipt output 22, and a local processing system 24 located inside the kiosk body 26.

The registration process is driven by a number of on-screen prompts and the corresponding patient reply. In one embodiment, the process includes four major steps: 1) scanning the barcode on the patient's hospital card; 2) scanning the patient's insurance card; 3) swiping the patient's insurance card; and 4) printing a receipt. This particular configuration was selected for the purpose of providing a robust disclosure to demonstrate the underlying principles and flexibility of the present invention. Variations will be apparent in light of this disclosure, and the present invention is not intended to be limited to any one such configuration.

For instance, an alternative embodiment may combine the hospital card and the insurance card into a single card. The card can be configured with a barcode or a magnetic strip that stores information. Alternatively, the card can be a smart card that has a built-in processor to store and process data. In such a case, note that the card is both readable and writable. As such, card reader 18 could also be capable of writing data to the card, if so desired. In any such case, the information on the single card can be read in one action using one type of reading technology, rather than having multiple cards and multiple reading technologies.

Likewise, the physical layout of the kiosk 10 and its features can be varied as desired. For example, if a graphical user interface employing touch screen technology is used, then a physical keyboard/mouse can be eliminated if so desired. In such an embodiment, a virtual keyboard or other user interface can be effected through conventional touch screen technology. In addition, the location of the input devices can be made more readily accessible by placing them on the kiosk body 26 (e.g., to accommodate a patient in a wheelchair) instead of the kiosk shelf. Generally stated, the configuration of the kiosk 10 can be ergonomically designed to accommodate all possible users. Secondary user interfaces, such as a Braille interface, audio interface, and voice recognition capability, can also be included in the kiosk 10 configuration.

Once the patient arrives at the healthcare provider's facility, she can approach the kiosk 10 and follow the instructions, whether they be on screen or otherwise (e.g., audio instructions). Each of the features illustrated in FIG. 1 will now be further discussed in detail.

Scan Barcode on Patient's Hospital Card

In this particular embodiment, the patient is greeted and asked to scan her hospital card. Many hospitals use such cards to uniquely identify each patient. The patient uses barcode scanner 12 device to scan the hospital card, which triggers a request for retrieval of the corresponding patient information currently on record, including the patient's name, address, and other pertinent information, such as date of birth and social security number. The request is received by a kiosk server that is communicatively coupled (e.g., via a network) with the kiosk 10. The kiosk server then accesses the requested information (e.g., stored in a network database) and sends it to the requesting kiosk 10 so that it can be displayed or otherwise communicated to the patient.

In the case where there is no hospital card to scan, the patient can simply be prompted to enter her name and/or other identifying information (e.g., social security) to initiate the retrieval process. Regardless of how initiated, the retrieved data is provided to the patient for review.

The user interface of kiosk 10 may then provide a prompt to the patient to confirm her identity. A password or secret question/answer combination can be used here to protect the patient's privacy. Various other security mechanisms can be employed (e.g., biometrics such as thumb print or eye scan). Once identity is confirmed, the retrieved information is provided for patient review. The patient is asked to confirm the accuracy of the retrieved information, and is given an opportunity to edit (e.g., add, delete, modify) the information as needed. In one embodiment, each piece of information is presented to the patient, and the patient can confirm the accuracy of each piece by selecting a “Yes” button. If “No” is selected for a piece of information, then that particular data field may be edited. Numerous data presentation and editing schemes can be used here.

Recall that the barcode scanner 12 could be a card swipe or any other mechanism for reading data from a card, whether the card includes a magnetic strip, barcode, memory device, or other information bearing means.

Scan Insurance Card

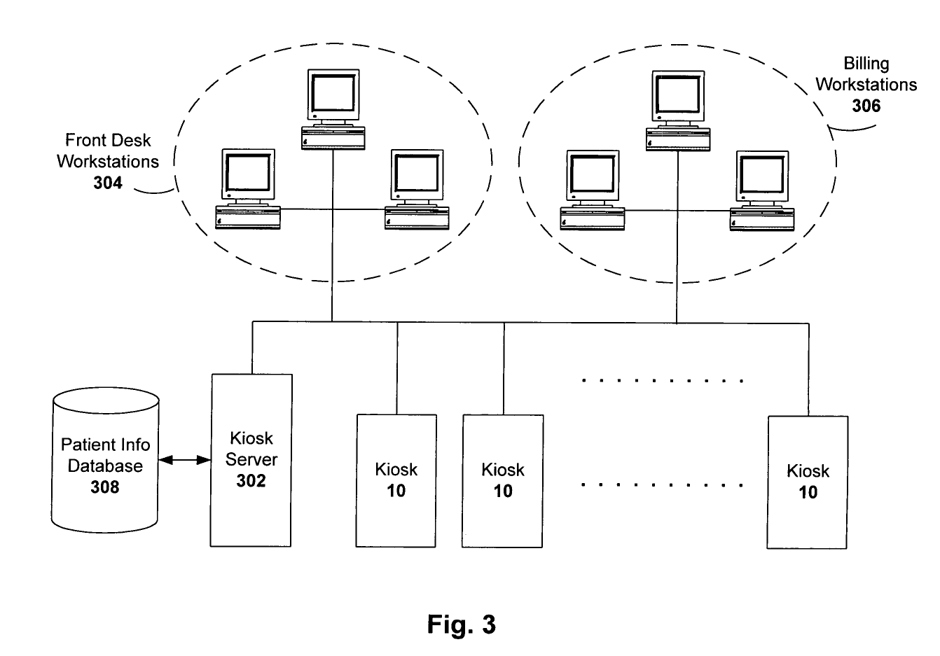

Once the retrieved patient information is updated or otherwise confirmed accurate, the patient is prompted to scan her insurance card using the card scanner 20. The patient feeds the insurance card into the slot of card scanner 20, and the card is scanned (front and back) and then returned to the patient. In one embodiment, kiosk system 10 is programmed to store the card image on a kiosk server (to be discussed in reference to FIGS. 3, 4, and 6) and date stamp it. Card scanner 20 can be implemented with conventional double-sided card continuous scanning techniques, such as those used to scan business cards. The card feeder and return mechanism can be similar to that used by automated teller machines (ATMs). Various other conventional card handling and scanning schemes can be used here.

In one particular embodiment, the image of the card and its date stamp is stored locally in the kiosk 10, and then automatically uploaded to the kiosk server periodically (e.g., every 2 minutes, on the hour, or everyday at midnight). Any one of a number of data storage and handling schemes can be programmed or otherwise configured into the system as will be apparent in light of this disclosure.

Swipe Insurance Card

Once the insurance card is scanned, the patient is prompted by the system to swipe her insurance card by using the card reader 18. Many insurance cards have a magnetic strip that encodes patient information and relevant insurance data. The magnetic strip on the insurance card is read by the conventional card reader 18, and the read information can then be transmitted electronically to the insurance company using known protocols, such as electronic data interchange (EDI) standards. This will allow the healthcare provider to assess relevant insurance information, including the patient's insurance eligibility.

Alternative embodiments may also be configured to handle insurance cards having no magnetic strip. For example, the image of the scanned insurance card can be interrogated for primary information, such as the patient's insurance company, policy number, and plan or group code. In one such particular embodiment, conventional optical character recognition (OCR) techniques are used to translate the image into a searchable ASCII file of data fields. The ASCII data of each field can then be cross-referenced to a look-up table (e.g., stored in a network database or locally in the kiosk 10) having current known information for all the insurance companies that are accepted by the healthcare provider. Such cross-referencing can be used to help identify the type of information in each field.

For instance, one field may contain “Blue Cross” or “Tufts” or the like. Cross referencing these terms with the database would identify the patient's insurance company. Another field might contain “Identification No.”, indicating that an adjacent field just to the right includes the patient's identification number. Similarly, another field might contain “Group No.”, indicating that an adjacent field just to the right includes the plan or group code. Similarly, another field might contain a “$”, indicating that an adjacent field just to the right includes the co-pay.

Note that once the patient's insurance information is electronically obtained from the image, it can be presented to the patient for confirmation to correct any mistakes that may have occurred in the translation process. As an alternative, the patient can simply be asked to enter the information from the card. In any event, patient and insurance information not electronically encoded on the card (e.g., for purposes of a card reader) can still be identified, and then transmitted electronically to the insurance company, to confirm eligibility.

Thus, the patient's insurance information (e.g., payor, plan, and eligibility for coverage) can be confirmed by the healthcare provider. For example, the requested information relevant to the patient's eligibility can be returned to the kiosk system from the insurance company or clearing house (e.g., call/response) in the form: “John Doe, XYZ insurance and plan, Insurance member # 002-30-4000, is eligible for coverage.” Alternatively, the response to the eligibility confirmation request could be: “John Doe, XYZ insurance and plan, Insurance member # 002-30-4000, is eligible for coverage; co-pay is $10.00” This information can be stored in the system's database.

Note that particularized eligibility, such as for specific services, can also be determined if so desired. Here, a description or the codes of the services sought could be provided in the eligibility confirmation request. The insurance company or clearing house could then review the plan indicated in the request for coverage of those codes, and report back accordingly. As an example, the response to the eligibility request might be: “John Doe, XYZ insurance and plan, Insurance member # 002-30-4000, is eligible for coverage for code 111 (annual physical); not eligible for code 5567-1 (rhinoplasty).” Variations will be apparent in light of this disclosure.

Print Confirmation/Receipt

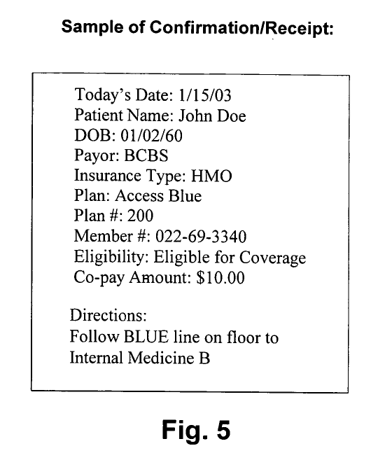

A confirmation and or receipt can be printed by the receipt output 22, which can be a conventional tape/receipt printer. The patient can retain the printed confirmation during her appointment, for supplemental check-ins or verifications that day. The confirmation includes patient-specific information, such as patient name, unique patient identifier, insurance payor name, plan name or type, patient insurance member number, eligibility confirmation, and co-pay amount. Other helpful information might include, for example, the location of the appointment and directions on how to get there from the particular kiosk 10 location. An example confirmation/receipt provided by receipt output 22 is illustrated in FIG. 5.

The patient's co-payment can be paid to a staff member of the healthcare provider. In an alternative embodiment, the kiosk 10 can also be adapted to receive co-payments. For example, once a patient's insurance information is verified, the co-payment amount is known. The kiosk can be equipped with a conventional cash-intake system (e.g., such as those used in change machines), or check-intake system (e.g., such as those used in retail/service settings, where the bank routing number, account number, and sufficient funds are confirmed). Alternatively, the payment-intake mechanism can be a conventional credit card based payment system. In addition to the payment of the co-pay, note that the patient could also be presented with a “patient balance” showing fees due for other services rendered. Here, the patient could be required or given an option to pay the outstanding balance in addition to the co-pay.

Kiosk Local Processing System

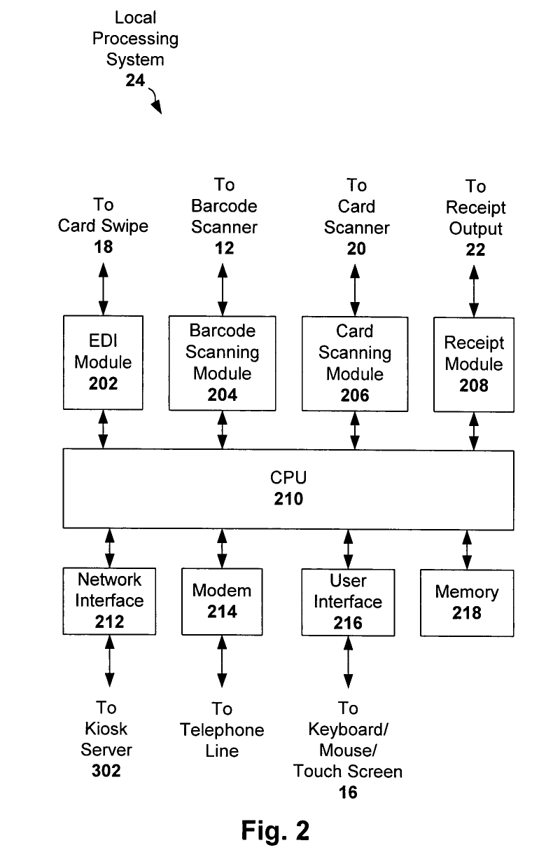

FIG. 2 is a block diagram of the kiosk local processing system 24 configured in accordance with one embodiment of the present invention. The system 24 includes an EDI module 202, a barcode scanning module 204, a card scanning module 206, a receipt module 208, a central processing unit (CPU) 210, a network interface 212, a modem 214, a user interface module 216, and a memory 218. This particular embodiment corresponds to the configuration of kiosk 10 illustrated in FIG. 1. Note, however, that the local processing system 24 can be adapted to correspond to various configurations of the kiosk 10 as discussed herein.

CPU 210 can be any one of a number of suitable processors for carrying out and/or directing the functionality described herein. Memory 218 can include both RAM and ROM portions, and can be implemented in numerous technologies (e.g., flash memory, EEPROM, SRAM). Each of the modules (202, 204, 206, 208, 212, and 216) can be, for example, implemented as a set of instructions or driver executing on CPU 210. Note that drivers may further be supported by corresponding hardware and/or firmware. The modules can be stored in a ROM portion of memory 218. Alternative embodiments may include a micro-controller unit that is programmed or otherwise configured with each of the components and modules illustrated in FIG. 2.

The EDI module 202 complies with an EDI standard (e.g., New England Healthcare EDI Network or NEHEN) and enables the system 24 to communicate with an insurance company. Thus, a determination of insurance eligibility can be efficiently carried out. Conventional modem 214 can be used to communicatively couple the system 24 to a health insurance company via, for example, a telephone line. Note that other communication mediums, however, can also be used here as well (e.g., fiber or cable).

The barcode scanning module 204 interfaces the barcode scanner 12 to the CPU 210, and facilitates the scanning of the patient's hospital card. The data encoded in the scanned barcode can be temporarily stored in local memory 218, and/or can be uploaded to a network kiosk server 302 via the network interface 212 (e.g., network interface card or wireless network interface). The network may be a local or wide area network, and include Internet access.

The card scanning module 206 interfaces the card scanner 20 to the CPU 210, and facilitates the scanning of the patient's health insurance card. The card scanning module 206 may further be adapted to perform OCR on the scanned image of the card. The image and OCR results can be temporarily stored in local memory 218, and/or can be uploaded to the network kiosk server 302 via the network interface 212 (e.g., network interface card or wireless network interface).

The receipt module 208 operates as an interface between the CPU 210 and the receipt output 22 (e.g., printer driver). The user interface 216 operates as the interface between the CPU 210 and the user interface devices of the kiosk 10. In the embodiment shown, a keyboard and mouse combination are provided. Other input devices (e.g., joystick, trackball) could also be used here. The user interface 216 can also be configured as a conventional touch screen driver and graphical user interface. A number of well-known user input schemes can be employed here to simplify the intake of patient information.

Note that the kiosk could be used to provide other information to the patient as well. For example, a map of hospital facility could be provided, where the patient puts in a doctor's name, which causes a map and directions to be provided that show the patient where she currently is in relation to the doctor's office. The patient can select a print button and print the map to guide her to the physician's office. In addition, a patient can enter a physician's name, and a bio or resume for that physician will be displayed. The patient can read online or print a copy if so desired.

Networked Patient Registration Kiosk System

FIG. 3 is a block diagram of a networked system including patient registration kiosks and various workstations in a healthcare provider setting, in accordance with one embodiment of the present invention. As can be seen, the system includes a number of front-end workstations 304 (e.g., front desk or reception workstations), a number of back-end workstations 306 (e.g., billing workstations), a number of patient registration kiosks 10, a kiosk server 302, and database 308 accessible by the server 302. Note that the database 308 can be integrated into the server 302. Each of the components can be communicatively coupled to the network with conventional technologies.

Generally, the front-end workstations 304 can be deployed near the reception area or at the point of service (e.g., department of patient's appointment). These workstations allow front-end staff to retrieve, display, and update any information put into the system at a kiosk 10 by a patient, including the scanned image of the insurance card. Thus, the required co-payment amount would be known, and could be collected by the front-end staff (if not yet collected).

The back-end workstations 306 can be deployed anywhere on the network (e.g., off-sight from the hospital campus or second floor of doctor's office), and allow billing staff to retrieve, display, and update any information put into the system at a kiosk 10 by a patient.

In addition, these front and back-end workstations allow the front and back-end staff to retrieve, display and update insurance plan information. In one embodiment, the database 308 stores current HTML pages of insurance plan information, also known as provider manuals. Such information is commonly provided in paper form by the insurance companies, but is readily convertible to HTML format for each payor accepted by the healthcare provider. Alternatively, such current HTML pages could be provided by HTML servers associated with each payor. In such a case, the user at a work station could access the appropriate HTML page server via the Internet using the kiosk server 302. Regardless of whether such HTML pages are stored locally to the healthcare provider or remotely at each payor's location, billing personnel can access current plan information using hypertext links and related conventional technology. Note that other suitable mark-up languages and page serving technology can be used here in the name of providing access to insurance plan information.

Additionally, a sample of each major payor's insurance card (as provided by the payor) could be scanned into the system and stored on the kiosk server 302 or in database 308. This would enable personnel (e.g., front-desk, physician, and billing) to review not only the patient's insurance card, but also this payor's sample insurance card. This could be done, for example, using a split screen, where the sample image is displayed on one side of the screen, and the patient card image is displayed on the other side of the screen. The benefit here is that billing or other staff members can see (per the sample image) what information should be found on the card, and where on the card, to locate this information. This will enhance the staff's ability to identify and select the correct payor and plan. The end result is accurate and timely claims submission and ultimately, prompt payment of claims.

The kiosk server 302 is configured to receive requests for information, and to retrieve and send that requested information to the requesting party (e.g., kiosk or workstation). In addition, the kiosk server 302 is configured to receive patient and insurance information, and to store it in database 308. Conventional client/server techniques can be employed to ensure that requests for data retrieval and storage are carried out properly. The kiosk server 302 may be implemented on one machine or on a number of machines (e.g., server farm).

Note that the functionality of a kiosk 10 can be integrated into a home computer system, thereby allowing the patient to perform all or part of the self registration process remotely. In such an embodiment, the patient could initiate the registration process by accessing the kiosk server 302 via the Internet (e.g., using an ISP). Pages served by the server 302 would allow the user to have a “virtual kiosk” experience, where patient and insurance information is provided, updated, or otherwise confirmed. The end result would be a “confirmation page” (e.g., similar to the receipt printed by the receipt output 22) that the patient could print and bring to a subsequent appointment. As the user's home computer may not have bar coding, scanning, or magnetic tape reading capability, the user interface of the “virtual kiosk” may be more question/answer oriented, thereby allowing the user to manually enter the needed information so that the automatic registration process as described herein can take place.

Interface to Billing Systems

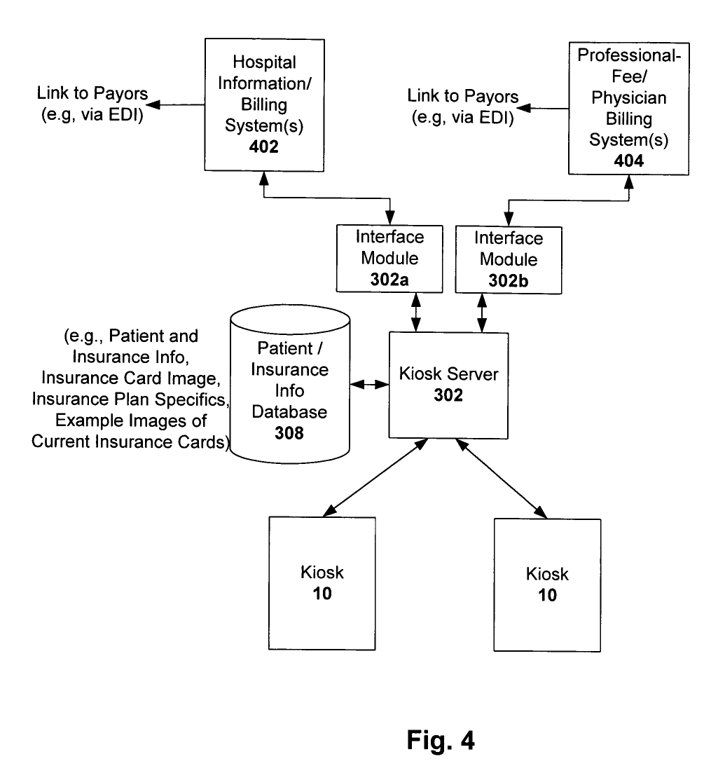

FIG. 4 is a block diagram of a kiosk server interfaced with various billing systems in accordance with one embodiment of the present invention. As discussed in reference to FIG. 3, the kiosk server 302 can be communicatively coupled to a number of workstations and kiosks 10. In an application where the workstations are associated with a billing function, a connection to a given payor via an EDI link can also be provided to allow transmittal of prepared electronic claims.

In this particular embodiment, a hospital information/billing system 402 and a physician or professional-fee billing system 404 are communicatively coupled with the kiosk server 302 via interface modules 302a and 302b, respectively. The interface modules 302a and 302b are shown as separate from the kiosk server 302, but can be integrated into the server as well. Note that one or multiple types of billing systems can be supported by the server 302. In an alternative embodiment, the billing system can be integrated into server 302. Further note that a physician billing system (non-hospital setting) can also be supported.

As previously discussed, the kiosk server 302 includes or otherwise has access to all the information confirmed by the patient and any derived information (e.g., patient's information and insurance plan specifics, health insurance card image). The kiosk server 302 also has access to information such as sample insurance cards and provider manuals provided by various payors.

The kiosk server 302 is configured with one or more interfaces that facilitate two-way communication between various billing entities. For example, when a kiosk 10 reads the patient's hospital card, a request is generated to download the patient data of record from, for example, the hospital information/billing system 402 to the kiosk 10 via interface 302a so that the data can be viewed and confirmed by the patient. Any updates or corrections made by the patient at the kiosk 10 can then be uploaded to the hospital system 402 via the interface 302a. If a professional-fee billing system 404 is used, then the communication between the billing system 404 and the server 302 via interface 302b need only be one way, so that the data provided by the patient at the kiosk 10 can be uploaded to populate the fields of the professional-fee system. However, a two-way communication interface could be used here as well if so desired.

Each interface 302a and 302b is programmed or otherwise configured to ensure that the fields of the corresponding billing system 402/404 are populated with the correct data. The interface may also perform other functions, such as language selection, font adjustment, encryption (e.g., to protect patient information), and data filtering (e.g., to prevent transmittal of patient data that is irrelevant to billing).

Regardless of the billing system type, the kiosk server 302 can be programmed or otherwise configured (e.g., interfaces 302a and 302b) to operate in conjunction with any such billing systems, so that a seamless integration of the kiosk system can be made without requiring a change to existing billing systems in use by the healthcare provider. The healthcare provider may be, for example, a hospital, doctor in private practice, or a medical clinic. The billing system can be any billing system, whether it be an existing system employed internally by the healthcare provider, or an external billing system of a service employed by the healthcare provider.

Note, however, that the kiosk system can also be configured as a stand alone system, where the kiosk server 302 further includes a billing system. Other hospital systems, such as a scheduling system may also be supported by the kiosk system. In such an embodiment, the front-end and back-end stations could access supported systems (e.g., billing, registration, scheduling, etc.) on the kiosk server 302. Conventional client-server techniques can be employed here as well.

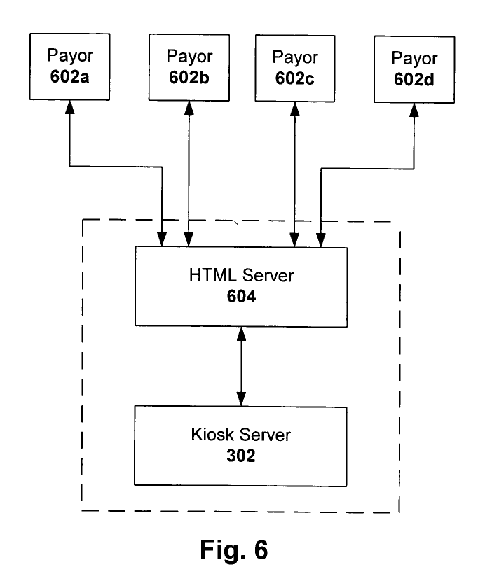

FIG. 6 is a block diagram of a kiosk server interfaced with a number of payors via an HTML server in accordance with one embodiment of the present invention. Here, a number of payors 602a-d are communicatively coupled with an HTML server 604, which is in turn coupled to the kiosk server 302. Note that the HTML server 604 and the kiosk server 302 can be integrated into one server. Each payor 602 can upload current versions of its provider manual and other relevant information (e.g., sample insurance card images) so that the healthcare provider can have full access to current and accurate payor information. Markup languages other than HTML can also be employed by server 604, such as XML.

As will be apparent in light of this disclosure, current HTML pages could also be provided by remote HTML servers associated with each payor. In such a case, the user at a work station could access the appropriate payor's HTML page server via the Internet using the kiosk server 302. While pages stored locally might provide a faster retrieval time (depending on the type of connection with which the healthcare provider accesses the Internet), remote page access may be preferred because payors are likely to keep their own sites current. This will remove the healthcare provider's burden of having to update HTML server 604. In addition, it is likely that most healthcare providers will have a high bandwidth connection to the Internet, thereby making page access time less of an issue. Thus, the local HTML server 604 is shown as an example, and is not intended to limit the present invention.

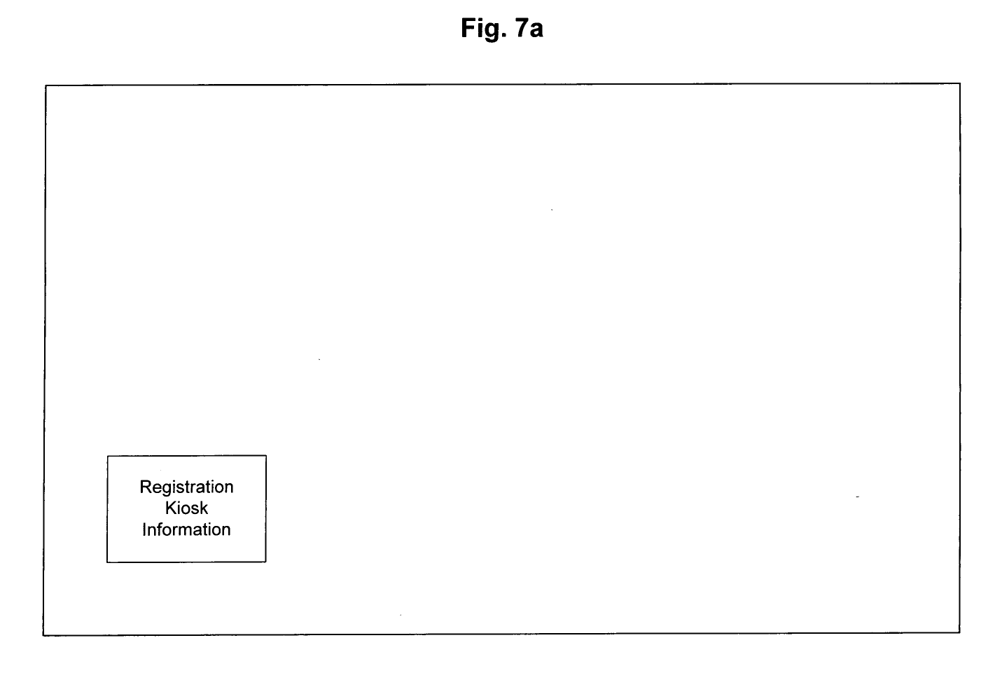

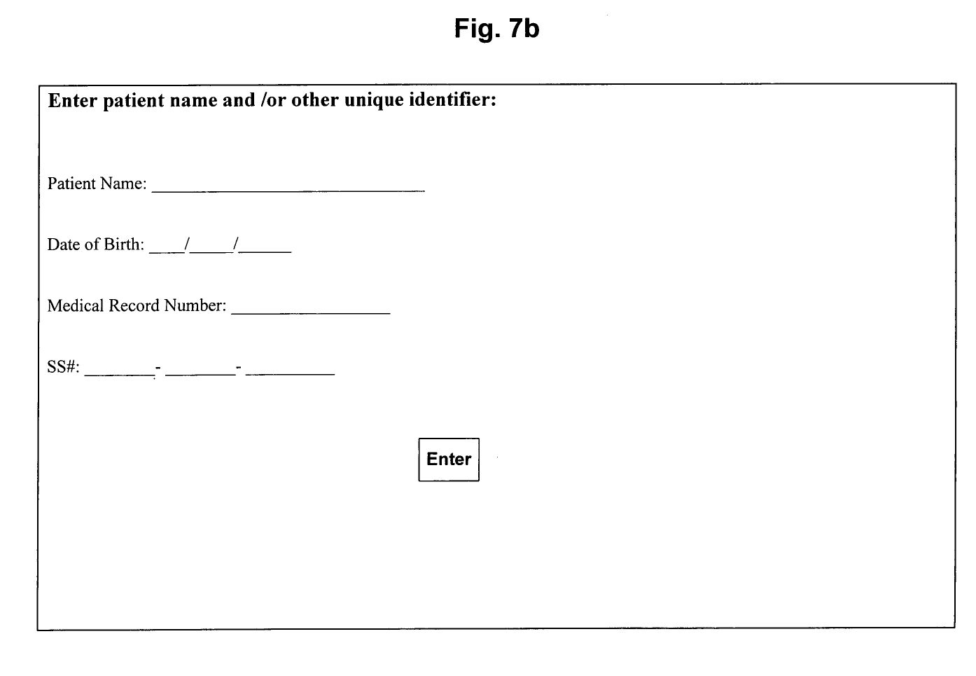

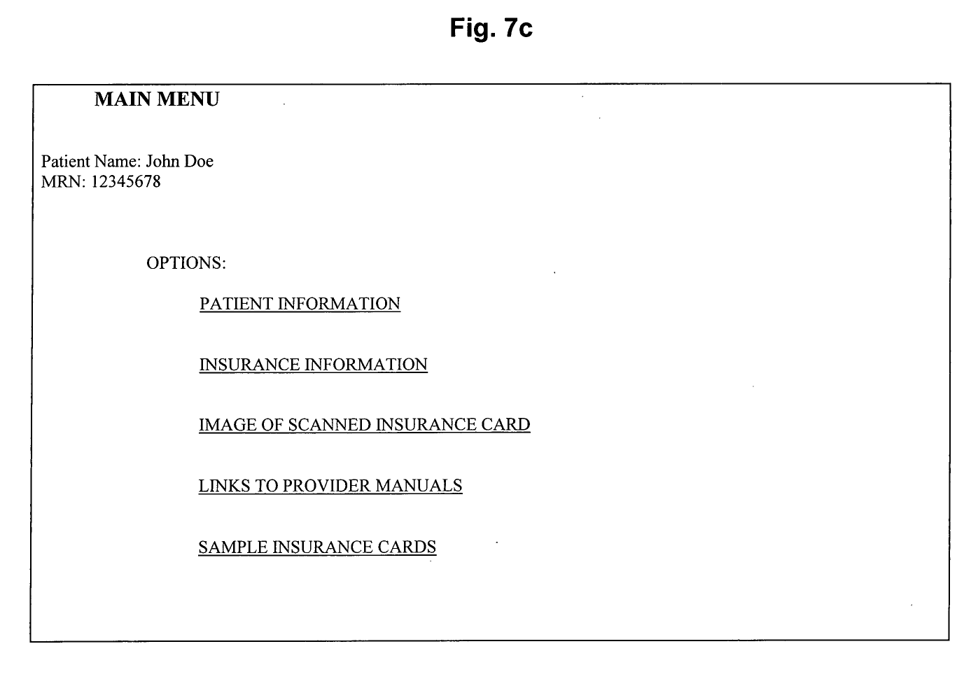

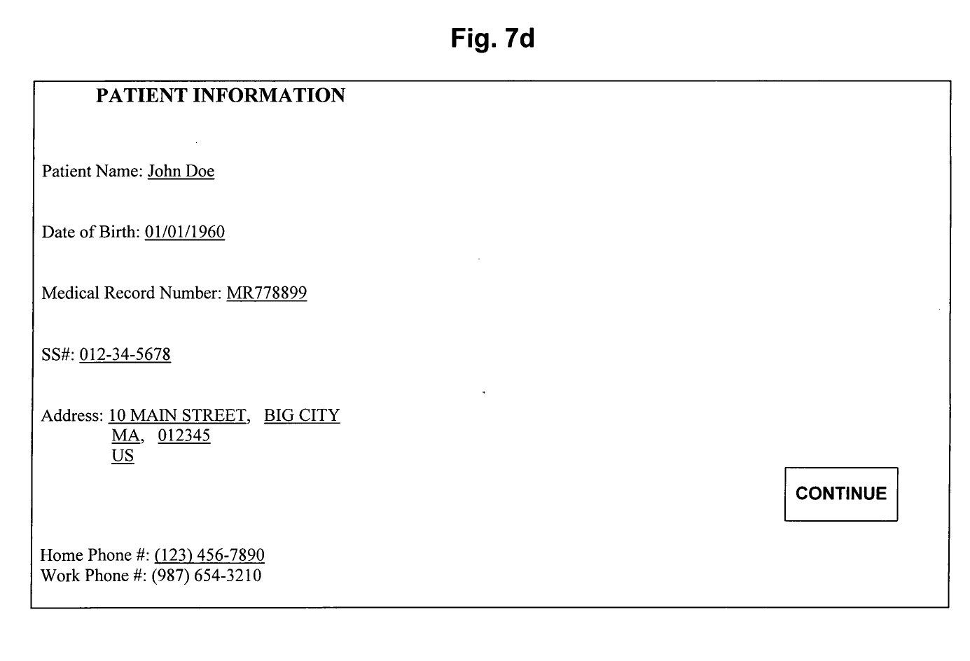

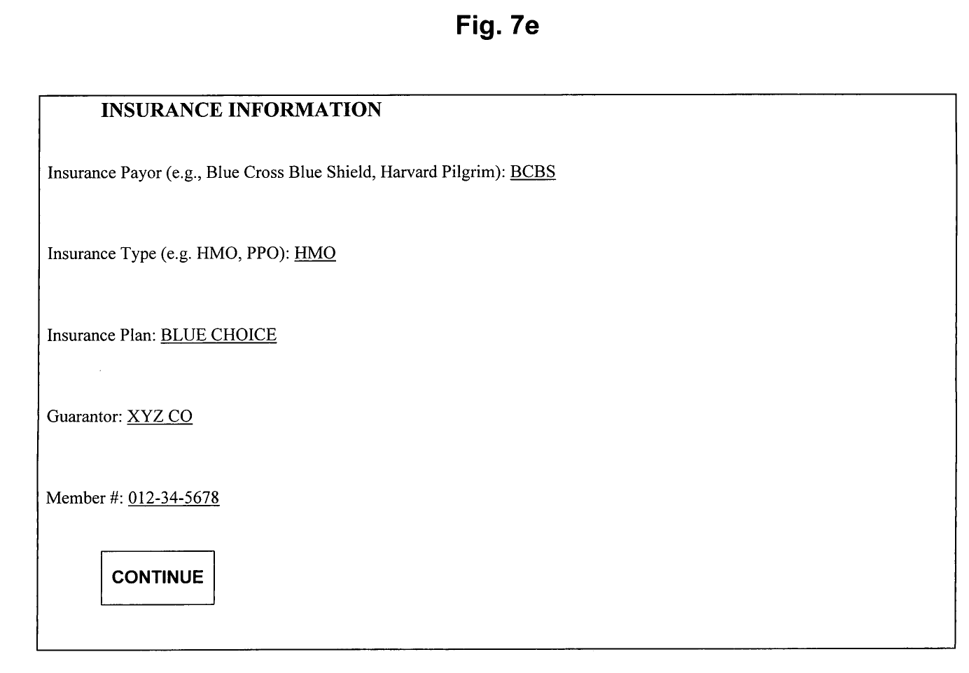

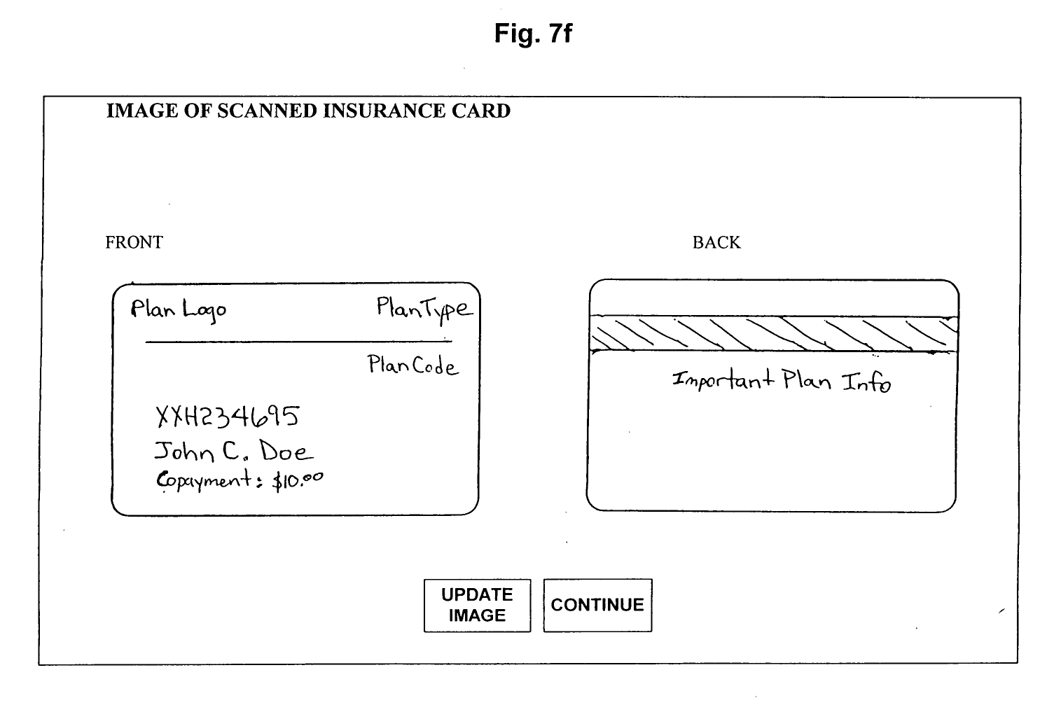

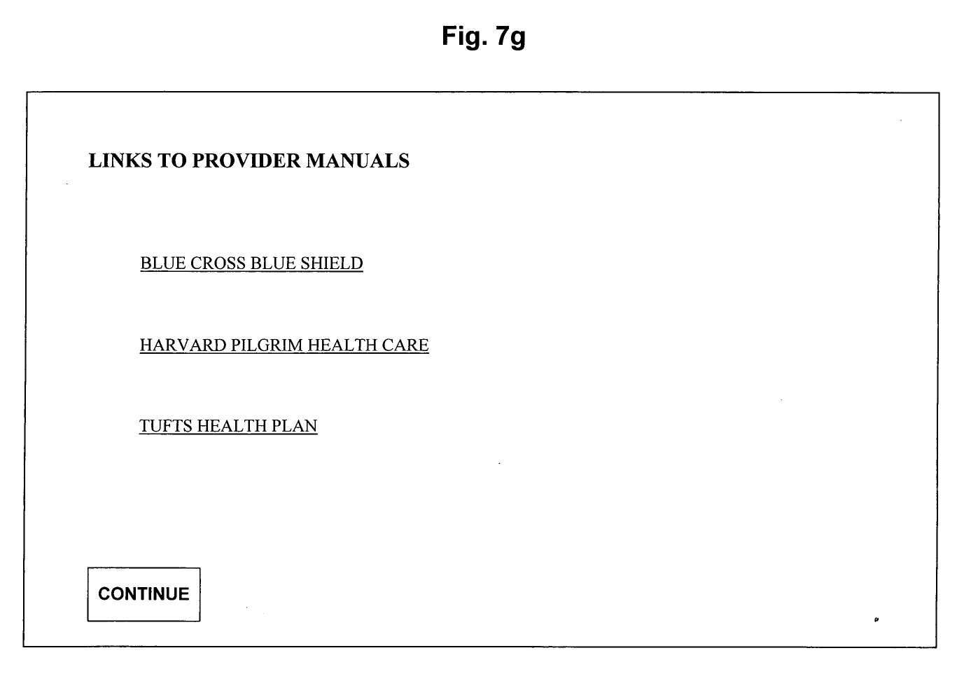

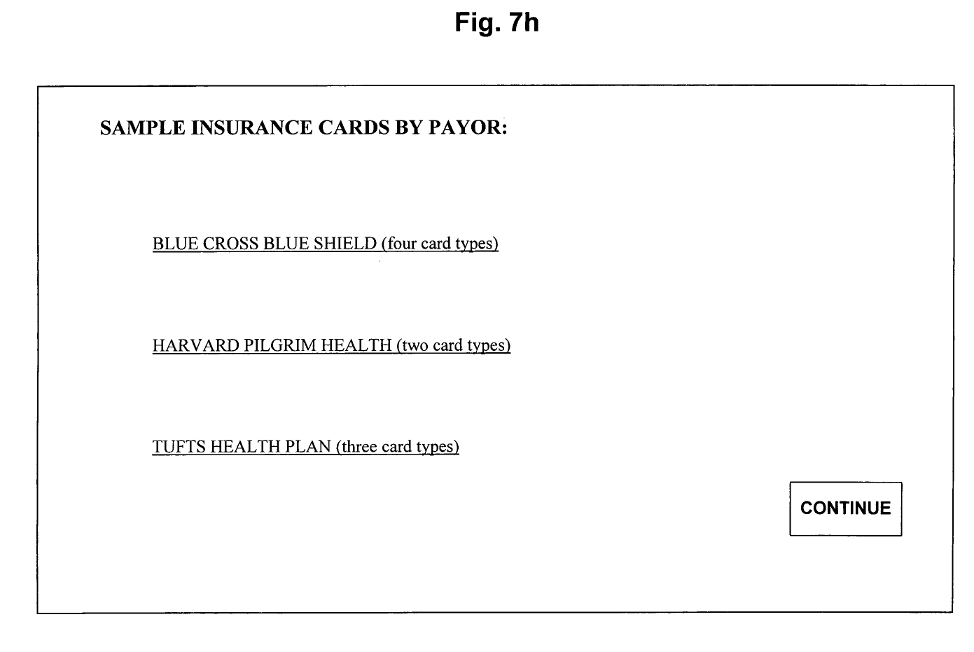

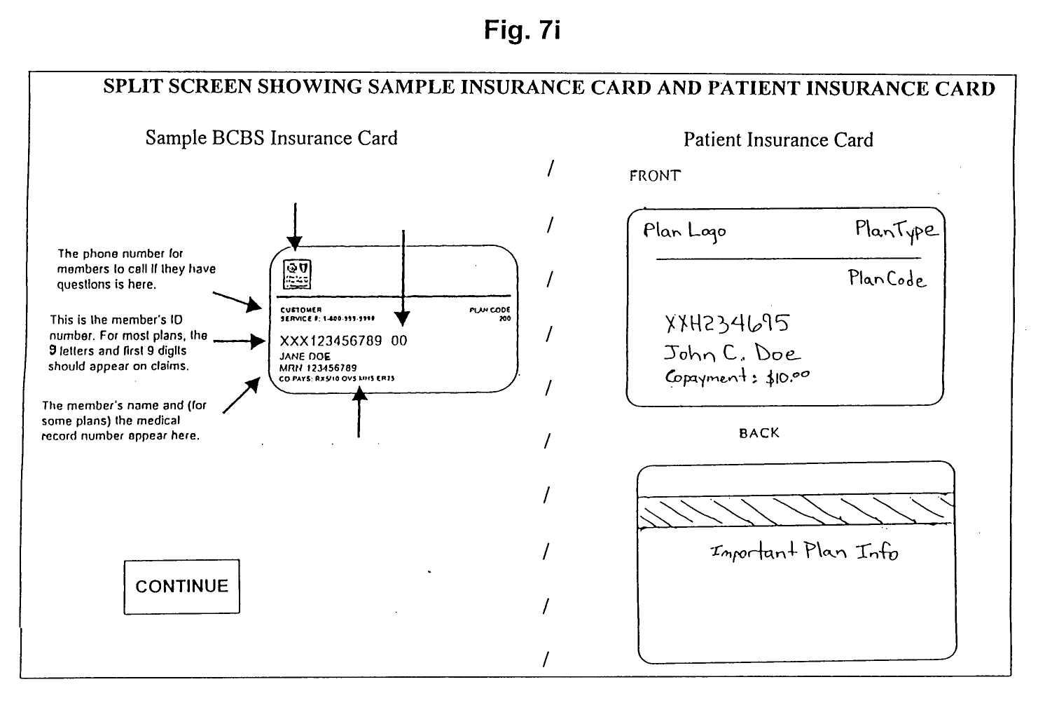

FIGS. 7a-7i illustrate example screen shots of a user interface for staff members (e.g., front desk and billing personnel) of a healthcare provider using a kiosk system configured in accordance with one embodiment of the present invention. FIG. 7a is the greeting screen that a staff member or user will see. Patient and Insurance information can be viewed and updated using the system. The process can be initiated by activating (e.g., clicking or touching) the Registration Kiosk Information button.

FIG. 7b prompts the user to enter a unique identifier of the patient. FIG. 7c presents the user with a confirmation (e.g., requested patient name and medical record number-MRN), and a Main Menu from which the user can choose a number of options. Numerous options may be provided as will be apparent in light of this disclosure. The Patient Information menu option is illustrated in FIG. 7d, while the Insurance Information menu option is illustrated in FIG. 7e. The fields of each screen are fully accessible by the user, thereby allowing corrections and updates if necessary. The user may proceed to the next screen by selecting the Continue button.

Note that other user interface features, such as Back and Next buttons, Stop or Cancel buttons, and Help buttons (e.g., for accessing an online help manual for the kiosk system, from a staff member perspective), may also be provided to the user. In addition, security features (e.g., password schemes and screen clearing routines) can also be included in the user interface.

FIG. 7f illustrates the Image of Scanned Insurance Card menu option. Both front and back images of the corresponding patient's insurance card are shown. If necessary, the user can select the Update Image button, and scan the patient's insurance card (e.g., using a front desk scanner communicatively coupled to the system). FIG. 7g illustrates the Links to Provider Manuals menu option. Recall that the links can be, for example, HTML links, or they can be links to scanned images or PDF files. Regardless, when the user selects a particular payor, the user is presented with currently available provider manuals stored on or otherwise accessible by the kiosk server.

FIG. 7h illustrates the Sample Insurance Cards by Payor menu option, which similarly allows the user to view the various sample card images (for each payor) accessible by the kiosk system. FIG. 7i illustrates a Split Screen Comparison menu option, which allows the user to compare a sample payor insurance card to a patient's insurance card. The location of pertinent information and its meaning is indicated on the sample card image, thereby allowing the user to properly interpret the patient's insurance card.

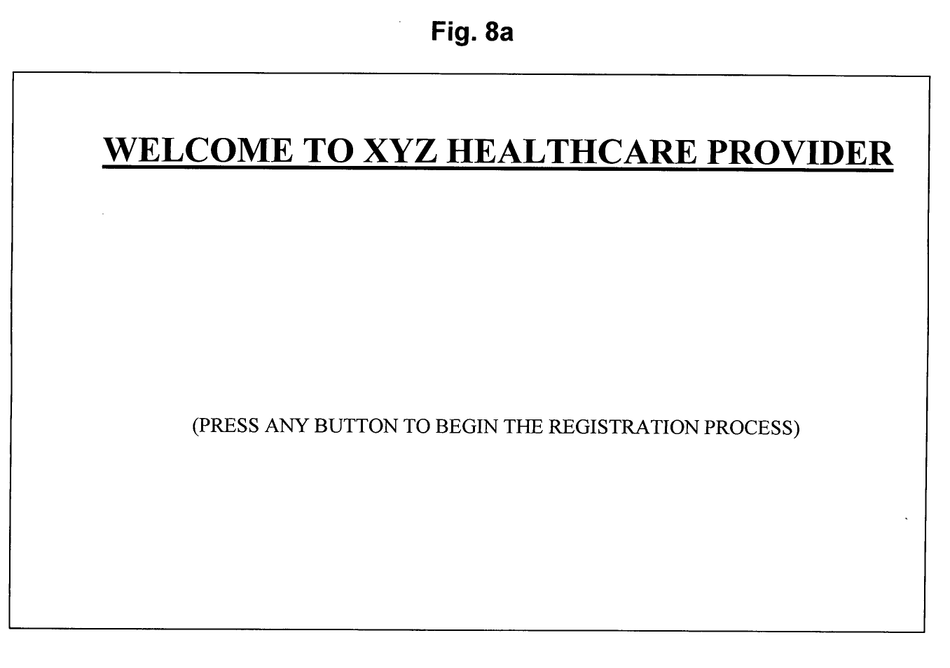

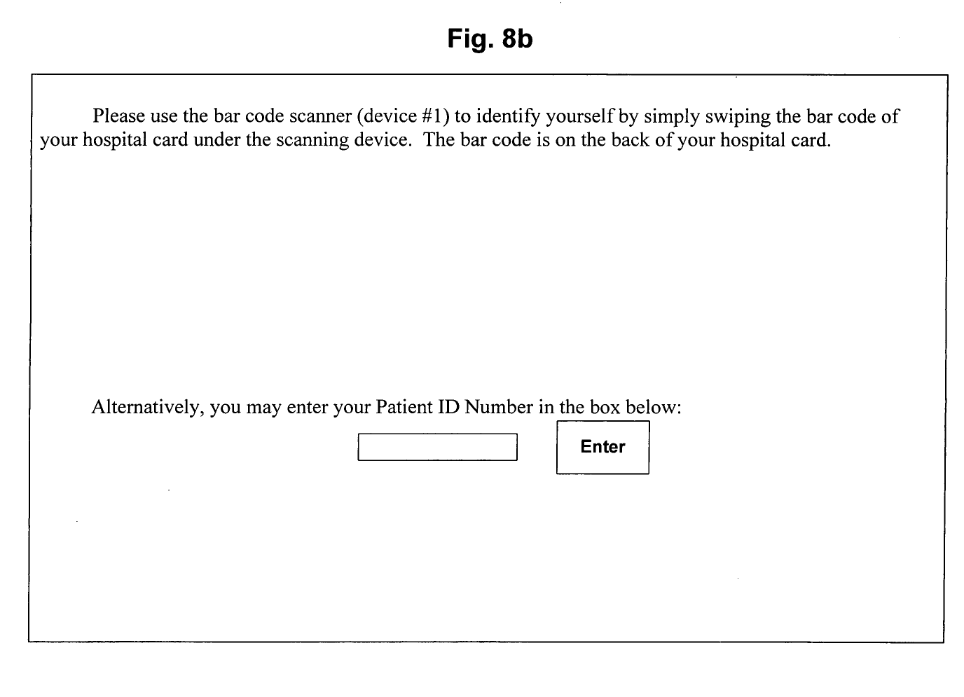

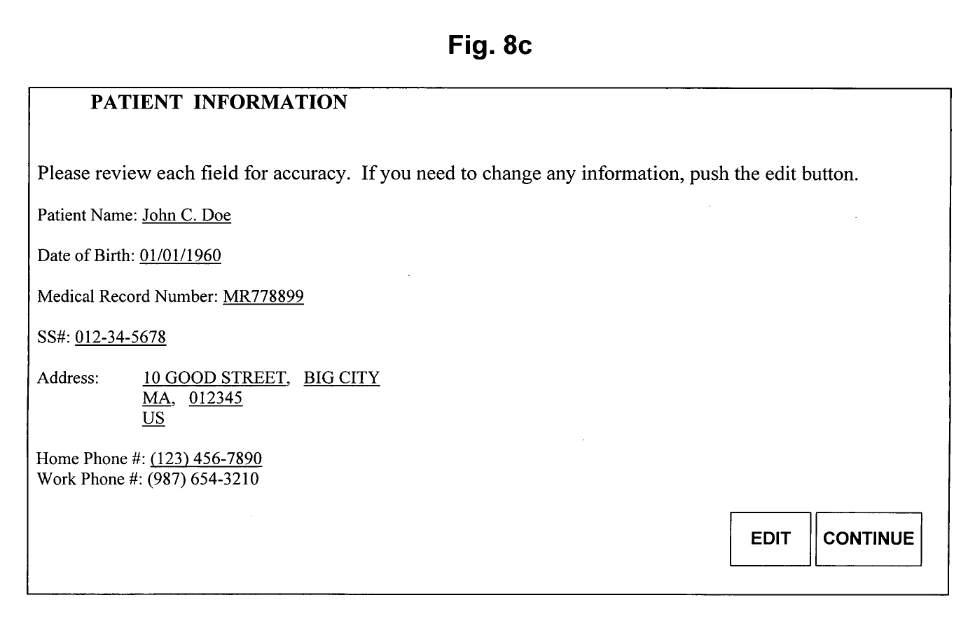

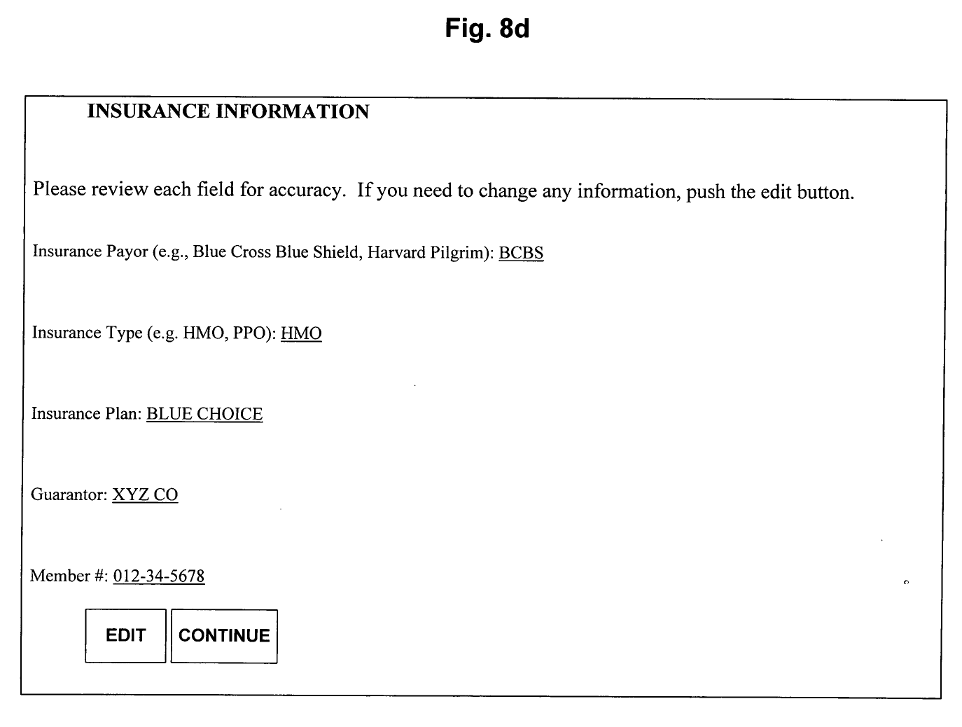

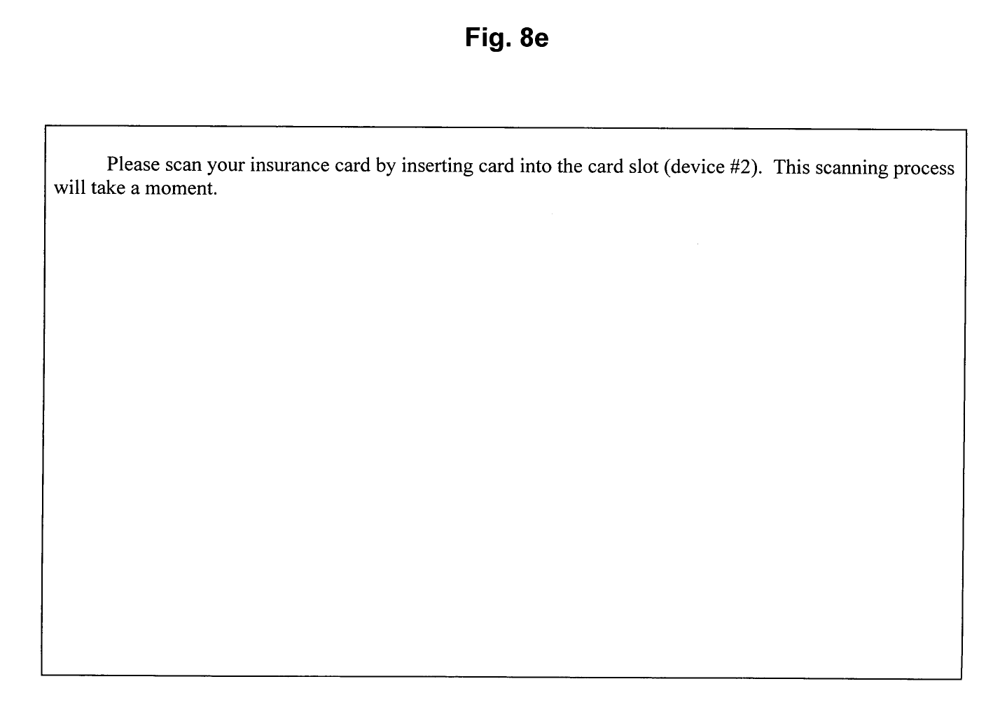

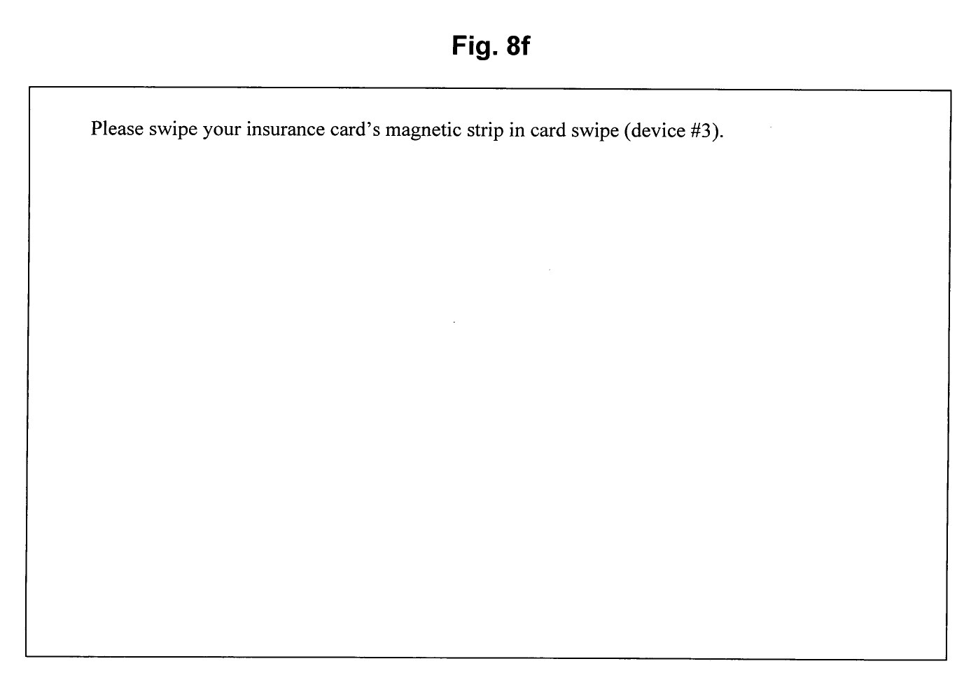

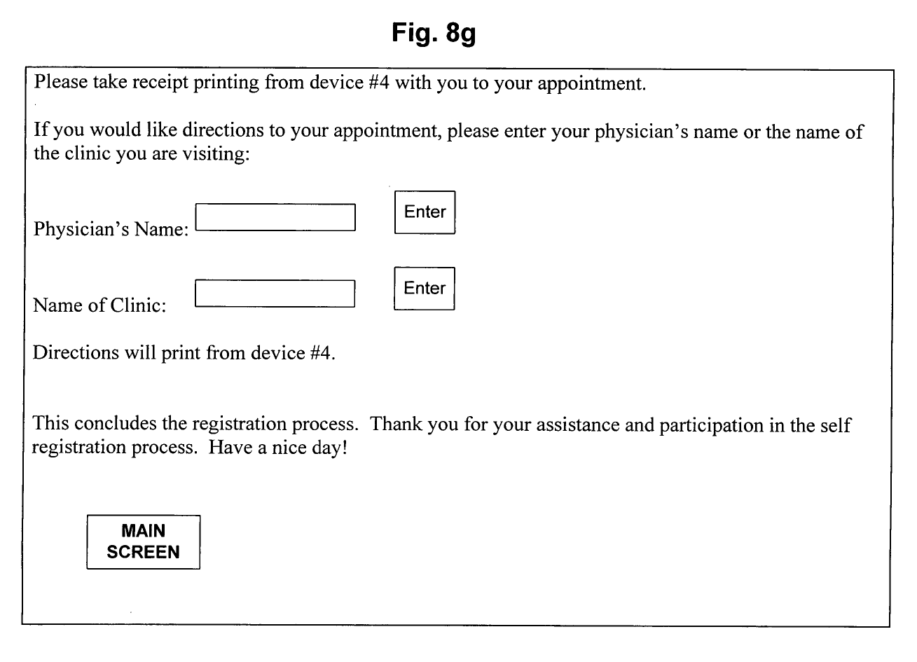

FIGS. 8a-8g illustrate example screen shots of a user interface for patients of a healthcare provider using a kiosk system configured in accordance with one embodiment of the present invention. FIG. 8a is the greeting screen that a patient will see. Patient and insurance information can be viewed and updated by the patient using the system. The process can be initiated, for example, by pressing any button or touching the screen. Just as with the staff screens discussed in reference to FIGS. 7a-g, the patient screens may also employ other user interface features, such as Back and Next buttons, Stop or Cancel buttons, and Help buttons (e.g., for accessing an online help manual for the kiosk system, from a patient's perspective).

FIG. 8b prompts the patient to move her hospital card under the barcode scanner so that she can be identified by the system, and her personal and insurance information can be retrieved. Alternatively, the patient is prompted to enter her Patient ID Number (e.g., social security number). This option could be used, for example, when the patient has forgotten/lost her hospital card, or the healthcare provider does not use such cards.

FIG. 8c illustrates the Patient Information screen, which presents the patient with the retrieved information, and allows the patient to edit as necessary. Once the information is correct, the patient can continue to the Insurance Information screen, which is illustrated in FIG. 8d. Again, the user may edit as necessary, and continues when appropriate. Recall that an intermediate screen (not shown) can be presented prior to displaying the patient's information, where the intermediate screen requires the patient to answer one or more security questions to ensure that the correct data will be displayed to the correct person.

The patient is then prompted to scan her insurance card, as illustrated in FIG. 8e. As insurance cards tend to be densely populated with important information, a new scan can be required for each patient visit. This would ensure that any changes to the insurance card changes would be electronically captured, thereby eliminating the opportunity for a staff member to inadvertently miss the change. However, in alternative embodiments, the patient may be given a chance to compare the images of her health insurance card currently on file with her current card, and to select an “Update Image” button if necessary. This option would reduce the need to scan the card every visit, as well as reduce the wear on the card scanner hardware.

The patient is then prompted to swipe the magnetic strip on her insurance card, as illustrated in FIG. 8f. This will allow insurance information including eligibility to be verified via an EDI link. Recall that if the insurance card is not equipped with a magnetic strip, then the image of the card can be interrogated so that the appropriate information can be extracted. Alternatively, the patient can simply enter the insurance information. In any case, the patient's insurance eligibility is verified. Further note that additional information from the healthcare provider (e.g., such as the codes that correspond to the medical services sought by the patient) may be sent along so that particularized eligibility verification can be carried out.

Once the claim eligibility check is performed, the user is prompted with a receipt as illustrated in FIG. 8g. Additional user interface features may also be provided, such as the option to get printed directions to the particular office or department being visited. The Main Screen button can be selected to bring the patient back to the Welcome screen of FIG. 8a.

An automatic time-out or watchdog module can be programmed to return the user interface back to the Welcome screen if no user activity is sensed in a given period of time. Also, security features may be instituted to protect privacy, such as password schemes and screen clearing routines. The Health Insurance Portability and Accountability Act of 1996 (HIPAA) and other such acts may be used as a guide here to ensure compliance with security and privacy requirements.

The foregoing description of the embodiments of the invention has been presented for the purposes of illustration and description. It is not intended to be exhaustive or to limit the invention to the precise form disclosed. Many modifications and variations are possible in light of this disclosure. For example, although this disclosure was given in the context of providing healthcare, the principles of the present invention can be employed in the context of any service organization that requires current and accurate data unique to a particular customer to be readily available to various parts of the organization. It is intended that the scope of the invention be limited not by this detailed description, but rather by the claims appended hereto.

What is claimed is:

1. A patient registration kiosk system that allows patients to self-register for an appointment with a healthcare provider, comprising:
a patient identification mechanism adapted to uniquely identify a patient so that information relevant to that patient can be retrieved from a database;
a user interface that presents the retrieved information to the patient and allows the patient to update the information as necessary, thereby maintaining current patient information in the database;
an insurance plan identification mechanism adapted to identify insurance plan information including a payor associated with the patient, thereby maintaining current insurance information in the database;
a data interface that enables the healthcare provider to form an electronic communication link with the payor to confirm the patient's eligibility for coverage by the payor, based on the identified insurance plan information; and
an insurance card scanner adapted to generate an image of each side of an insurance card associated with the patient for storage in the database.

2. The kiosk system of claim 1 further comprising:
an output device adapted to provide a receipt relevant to the patient's appointment, the receipt including at least one of patient name, unique patient identifier, insurance payor name, plan name or type, patient insurance member number, eligibility confirmation, and office co-pay amount.

3. The kiosk system of claim 1 wherein the patient identification mechanism includes one of a barcode scanner and a card reader.

4. The kiosk system of claim 1 wherein the user interface includes a touch screen graphical user interface that allows the patient to interact with the kiosk system.

5. The kiosk system of claim 1 wherein the insurance plan identification mechanism includes one of a barcode scanner and a card reader.

6. The kiosk system of claim 1 wherein the data interface forms part of an electronic data interchange (EDI) between the healthcare provider and the payor.

7. The kiosk system of claim 1 further comprising:
a processor in communication with one or more of the patient identification mechanism, the user interface, the insurance plan identification mechanism, the data interface, and the insurance card scanner, wherein the processor is configured for controlling functionality of the kiosk system.

8. The kiosk system of claim 1 wherein the kiosk system is coupled to a network that includes at least one of a front desk workstation and a billing workstation, with each workstation having access to the database.

9. The kiosk system of claim 1 wherein the kiosk system is coupled to a network that includes a server that communicatively couples the database to the kiosk system.

10. The kiosk system of claim 9 wherein the server communicatively couples the database and the kiosk system to a billing system associated with the healthcare provider.

11. The kiosk system of claim 10 wherein the data interface operates in conjunction with the server and the billing system to form the electronic communication link between the healthcare provider and the payor to confirm the patient's eligibility for coverage.

12. A patient registration kiosk system that allows patients to self-register for an appointment with a healthcare provider, comprising:
a barcode scanner adapted to uniquely identify a patient so that information relevant to that patient can be retrieved from a database;
a user interface that presents the retrieved information to the patient and allows the patient to update the information as necessary, thereby maintaining current patient information in the database;
a card reader adapted to identify insurance plan information including a payor associated with the patient, thereby maintaining current insurance information in the database;
a data interface that allows the healthcare provider to confirm the patient's eligibility for coverage by the payor based on the identified insurance plan information;
an insurance card scanner adapted to generate an image of each side of an insurance card associated with the patient for storage in the database; and
an output device adapted to provide a paper receipt relevant to the patient's appointment, the receipt including at least one of patient name, unique patient identifier, insurance payor name, plan name or type, patient insurance member number, eligibility confirmation, and office co-pay amount.

13. The kiosk system of claim 12 wherein the user interface includes a touch screen graphical user interface.

14. The kiosk system of claim 12 further comprising:
a processor in communication with one or more of the barcode scanner, the user interface, the card reader, the data interface, and the insurance card scanner, wherein the processor is configured for controlling functionality of the kiosk system.

15. The kiosk system of claim 12 wherein the kiosk system is coupled to a network that includes at least one of a front desk workstation and a billing workstation, with each workstation having access to the database.

16. The kiosk system of claim 12 wherein the kiosk system is coupled to a network that includes a server that communicatively couples the database, the kiosk system, and a billing system associated with the healthcare provider, wherein the data interface operates in conjunction with the server and the billing system to form a communication link between the healthcare provider and the payor to confirm the patient's eligibility for coverage.

17. A patient registration kiosk system that allows patients to self-register for an appointment with a healthcare provider, comprising:
a patient identification mechanism adapted to uniquely identify a patient so that information relevant to that patient can be retrieved from a database;
a user interface that presents the retrieved information to the patient and allows the patient to update the information as necessary, thereby maintaining current patient information in the database;
an insurance plan identification mechanism adapted to identify insurance plan information including a payor associated with the patient, thereby maintaining current insurance information in the database; and
a data interface that allows the healthcare provider to confirm the patient's eligibility for coverage by the payor based on the identified insurance plan information.

18. The kiosk system of claim 17 wherein the kiosk system is coupled to a network that includes a server that communicatively couples the database to the kiosk system.

19. The kiosk system of claim 18 wherein the server has electronic access to current payor provider manuals.

20. The kiosk system of claim 18 wherein the server has electronic access to sample insurance card images associated with one or more payors.

21. The kiosk system of claim 17 wherein at least one of a network and a server communicatively couple the database and the kiosk system to a billing system associated with the healthcare provider.

22. The kiosk system of claim 21 wherein the data interface operates in conjunction with the server and the billing system to establish electronic communication between the healthcare provider and the payor to confirm the patient's eligibility for coverage.

23. The kiosk system of claim 17 wherein the kiosk system is coupled to a network that includes at least one of a front desk workstation and a billing workstation, with each workstation having access to the database.

24. The kiosk system of claim 23 wherein each workstation has electronic access to current versions of payor provider manuals and sample insurance card images.

25. The kiosk system of claim 23 wherein at least one of the workstations is adapted to provide a split-screen display that allows a staff member of the healthcare provider to compare images of an insurance card associated with the patient with sample insurance card images provided by the payor.

26. The kiosk system of claim 17 further comprising a payment-intake mechanism configured to receive payment including at least one of a co-pay and an outstanding balance associated with the patient.

27. The kiosk system of claim 17 wherein the data interface further allows the healthcare provider to confirm a co-pay associated with the patient.

28. The kiosk system of claim 17 wherein the data interface further allows the healthcare provider to confirm particular plan benefits associated with the patient.

29. The kiosk system of claim 17 wherein the identified insurance plan information further includes a specific plan associated with the patient.
